(19) United States
(12) Patent Application Publication
(10) Pub. No.: US 2014/0252766 A1
(43) Pub. Date: Sep. 11, 2014

(54) SHAPE CHANGING WAVE ENERGY CONVERTER

(71) Applicant: LOCKHEED MARTIN CORPORATION, Bethesda, MD (US)

(72) Inventors: Richard P. CLARK, Palm Beach Gardens, FL (US); Floria E. CLEMENTS, Palm Beach Gardens, FL (US)

(73) Assignee: LOCKHEED MARTIN CORPORATION, Bethesda, MD (US)

(21) Appl. No.: 14/196,138

(22) Filed: Mar. 4, 2014

Related U.S. Application Data
(60) Provisional application No. 61/774,701, filed on Mar. 8, 2013.

(51) Int. Cl. F03B 13/14

(52) U.S. Cl. CPC F03B 13/14
USPC 290/42; 290/53

(57) ABSTRACT

A wave energy converter is described that can change shape to mechanically tune itself to change the amount of water that the converter pushes up and down. In effect, the wave energy converter employs variable virtual added mass to tune the wave energy converter to the waves, thereby increasing the energy extraction from the waves. The shape change or variable virtual added mass type system can be employed on any type of wave energy converter including, but not limited to, point absorber wave energy converters.

### FIELD

This disclosure relates to a wave energy converter that converts wave energy into useful energy such as electrical energy.

### BACKGROUND

The use of wave energy converters that convert wave energy into electrical energy or other useful energy is well known. Many different designs of such wave energy converters exist.

Waves occur at a spectrum of periods with different amplitudes at each period. Existing wave energy converters work continuously to create “resonance” with the changing waves to maximize their energy extraction. Creating resonance with waves requires changing the dynamic response characteristics of the wave energy converter, which adds complexity to the system.

One known technique for creating resonance is to use electrical tuning of the power take off system and diverse control schemes to change the converter's dynamic response characteristics. Although electrical tuning systems enhance energy extraction, they come with associated cost, weight, reliability, and maintainability challenges.

### SUMMARY

A wave energy converter is described that can change shape to mechanically tune itself to change the amount of water that the converter pushes up and down. In effect, the wave energy converter employs variable virtual added mass to tune the wave energy converter to the waves, thereby increasing the energy extraction from the waves.

The described shape change of the wave energy converter can be used separately from or to augment electrical tuning The shape change or variable virtual added mass type system described herein can be employed on any type of wave energy converter including, but not limited to, point absorber wave energy converters.

In one embodiment, the wave energy converter includes a float that has a first or standard float area. A means is connected to the float that is configured to selectively and controllably increase the standard float area. In a top plan view, the means is disposed to the side of the float such that in the top plan view, the area of the float can be selectively and controllably increased. The means can have any configuration that is suitable for selectively and controllably increasing the standard float area or the top plan view area that is acted on by the water. The means permits mechanical tuning of the wave energy converter by altering its area, and thereby changing the amount of water that is pushed up and down by the float under wave action.

In one embodiment, the area can be modulated intermittently in response to the bulk condition or state of the sea. In another embodiment, the area can be modulated frequently in response to individual waves.

In another embodiment, a wave energy converter includes a float having a float area, and a shape change means is attached to the float that is selectively and controllably actuatable to increase the float area that is acted on by the water.

In another embodiment, a wave energy converter includes a float having a float area, and a shape change mechanism is attached to the float. The shape change mechanism includes a plurality of flaps that are selectively and controllably actuatable between a fully open position and a fully closed position to increase the float area that is acted on by the water.

In still another embodiment, a method of mechanically tuning a wave energy converter includes selectively and controllably changing the shape of a float using a shape change mechanism connected to the float to change the amount of water that the converter pushes up and down.

### DRAWINGS

FIG. 1 is a perspective view of one embodiment of a shape changing wave energy converter described herein.

FIG. 2 is a side view of the shape changing wave energy converter of FIG. 1.

FIG. 3 is a top plan view of the shape changing wave energy converter of FIG. 1 with one exemplary shape change.

FIG. 4 is a side view of FIG. 3.

FIG. 5 is a perspective view of the shape changing wave energy converter of FIG. 1 with another exemplary shape change.

FIG. 6 illustrates an example of a module that can be used to form the shape changing wave energy converter of FIG. 1.

FIG. 7 is a detailed view of the flap actuating mechanism in a flaps closed position.

FIG. 8 is a detailed view of the flap actuating mechanism in a flaps open position.

FIG. 9 is a perspective view of another embodiment of a shape changing wave energy converter described herein.

FIG. 10 is a perspective view of still another embodiment of a shape changing wave energy converter described herein.

### DETAILED DESCRIPTION

As described further below, a shape changing or virtual added mass wave energy converter is described that can change shape to mechanically tune the wave energy converter to change the amount of water that the converter pushes up and down. In effect, the wave energy converter employs variable virtual added mass (from the change in the amount of water being forced up and down) to tune the wave energy converter to the waves.

In general, the wave energy converter can include a float of some form that has a first or standard float area. A shape change means is connected to the float that is configured to selectively and controllably increase the standard float area. In a top plan view, the shape change means is disposed to the side of the float such that in the top plan view, the area of the float that is acted on by the water is selectively and controllably increased. The shape change means can have any configuration that is suitable for selectively and controllably increasing the standard float area or the top plan view area that is acted on by the water. By changing the area of the float, the amount of water that is pushed up and down by the float under wave action is changed. In addition, if the shape change means fails, the converter still functions because the float will still work.

The shape change or virtual added mass type system described herein can be employed on any type of wave energy converter system. The examples described below utilize point absorber wave energy converters. However, other types of wave energy converter systems can be utilized.

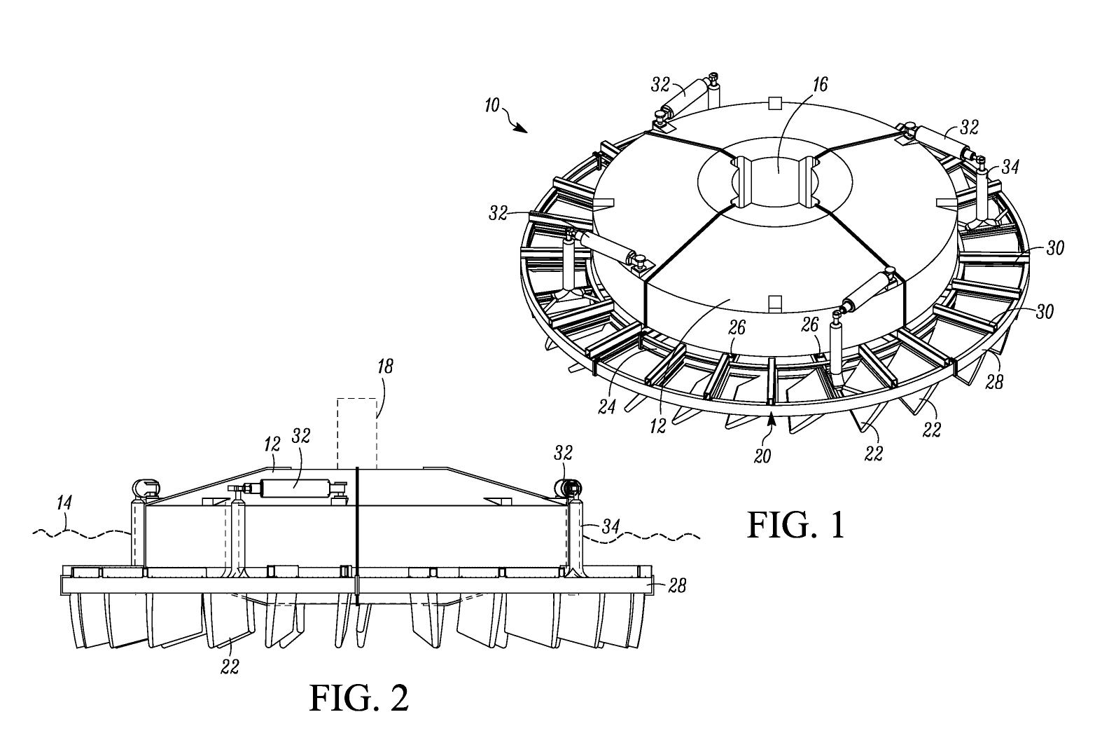

With reference initially to FIGS. 1-5, a first embodiment of a shape changing wave energy converter 10 is illustrated. The wave energy converter 10 in FIGS. 1-5 is a point absorber wave energy converter. The wave energy converter 10 includes a float 12 of generally known construction and that is available from Ocean Power Technologies, Inc. of Pennington, N.J. The float 12 is designed to float in the water so that approximately the lower half of the float is disposed below the water surface 14 and approximately the upper half is disposed above the water surface.

The float 12 includes a central opening 16 through which a mast 18 extends. The float 12 moves up and down on the mast 18 relative thereto. This relative movement is used to generate electricity in a known manner. The construction and operation of the float 12 described so far is conventional.

A shape change means 20 is connected to the float 12 so that the shape change means 20 is disposed under the water surface 14 with the bottom half of the float 12. In this example, the shape change means 20 is in the form of a panel mechanism that includes a series of panels or flaps 22 with orientations that can be selectively controlled. The shape change means 20 surrounds the float 12, with an inner support ring 24 that is fixed to the float 12 by supports 26, an outer support ring 28, and radial supports 30 that connect the inner ring 24 and the outer ring 28.

The flaps 22 have upper ends that are pivotally mounted to the inner ring 24 and the outer ring 28 via pivots 29 (see FIGS. 6-8). The inner and outer rings 24, 28 define facing tracks, and each flap 22 is actuated by a flap actuating mechanism 31 that is rotatably disposed in the tracks. In one embodiment, the shape change means 20 and thus the flaps 22 and flap actuating mechanism 31 are divided into quarter sections, and an actuator 32 is provided for each quarter section. One end of each actuator 32 is fixed to the top half of the float 12, while the opposite end of each actuator is fixed to a vertical bar 34 that is connected to the flap actuating mechanism 31 in the tracks.

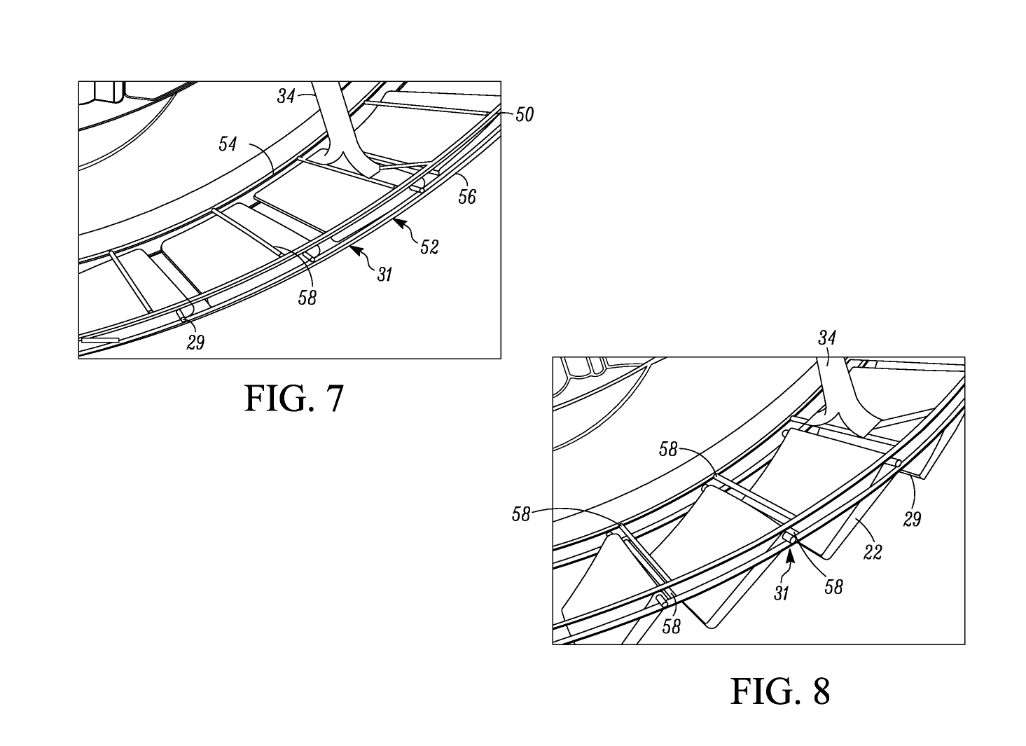

With reference to FIGS. 7 and 8, the flap actuating mechanism 31 includes an upper ring 50 and a lower ring 52 that are slidably disposed in the rings 24, 28. Each of the rings 50, 52 includes an inner ring portion 54 and an outer ring portion 56. Bars 58 extend between the inner and outer ring portions 54, 56 of the upper and lower rings 50, 52. As described above, the flaps 22 are attached to the pivots 29 that are pivotally attached to the rings 24, 28. The cylinders 32 are connected to the flap actuating mechanism 31 via the vertical bar 34 to actuate the flap actuating mechanism 31 circumferentially relative to the rings 24, 28. As the flap actuating mechanism 31 is rotated, the spaced bars 58 cause the flaps to pivot upward with the flaps moving between the bars 58 as shown in FIG. 7. Since the flaps 22 are disposed between the bars 58, the flaps are now trapped between the bars 58 of the upper and lower rings 50, 52 so the flaps cannot move.

Each actuator 32 is oriented substantially perpendicular to the heave action of the float 12. In this way, the actuator 32 does not have to be particularly strong since it only has to actuate the flap actuating mechanism 31.

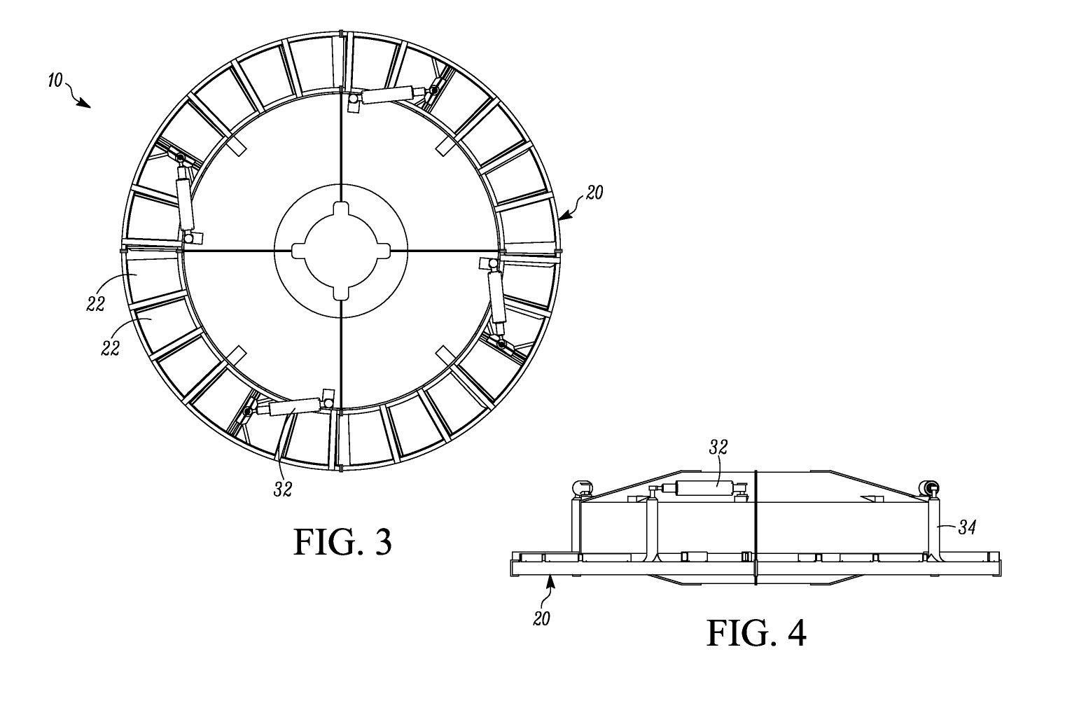

By extending and retracting the actuators 32, the orientation of the flaps 22 can be changed by the flap actuating mechanism. FIGS. 1 and 2 show all of the flaps in a fully open position. In the open position, the flaps add little additional area to the float 12 providing little virtual added mass. FIG. 3 illustrates all of the flaps 22 in a fully closed position. In the closed position, the area of the float 12 is maximized providing maximum virtual added mass. The flaps 22 can be actuated to any orientation between the fully open and fully closed positions, allowing multiple virtual added mass settings including low, high and settings in between.

In one embodiment, the flaps 22 remain in the selected orientation during both upward movement of the float 12 and downward movement of the float. However, it is possible to vary the flap orientation during the upward and downward strokes.

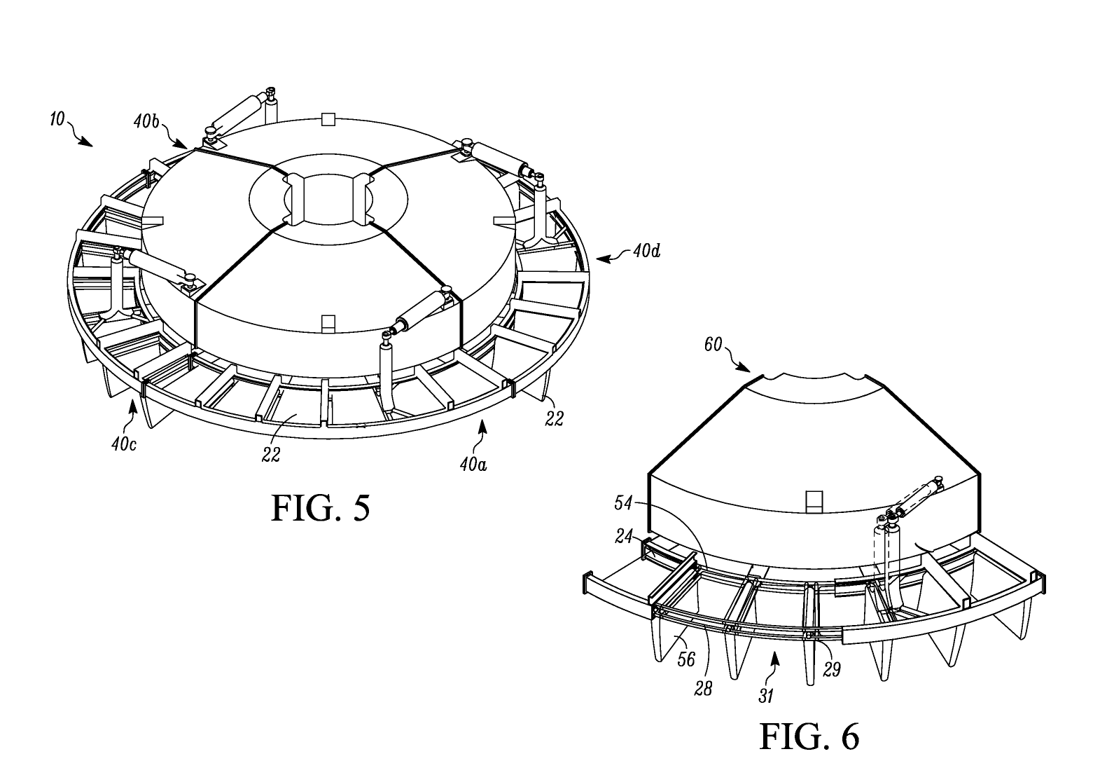

In addition, because the shape change means 20 and the flaps 22 are divided into sections, the orientations of the flaps 22 need not be the same. For example, as illustrated in FIG. 5, the flaps 22 of one or more sections, such as two opposite sections 40a, 40b can be fully closed, while the flaps of the sections 40c, 40d can remain fully open or be at different orientations than the sections 40a, 40b. Thus, the flaps of the sections 40a-d can be oriented to selectively change the amount of virtual added mass of the system, thereby better mechanically tuning the system.

With reference to FIG. 6, the float 12 and the shape change means 20 can be divided into modules 60, for example quarter sections. The modules 60 are secured together to form the converter 10 including the float 12 and the shape change means 20. By employing modules 60, repairs to the converter 10 are facilitated. The module 60 need not include a portion of the float and a portion of the shape change means. Instead, the float 12 can be made of modular sections, and the shape change means 20 can be formed from separate modular sections.

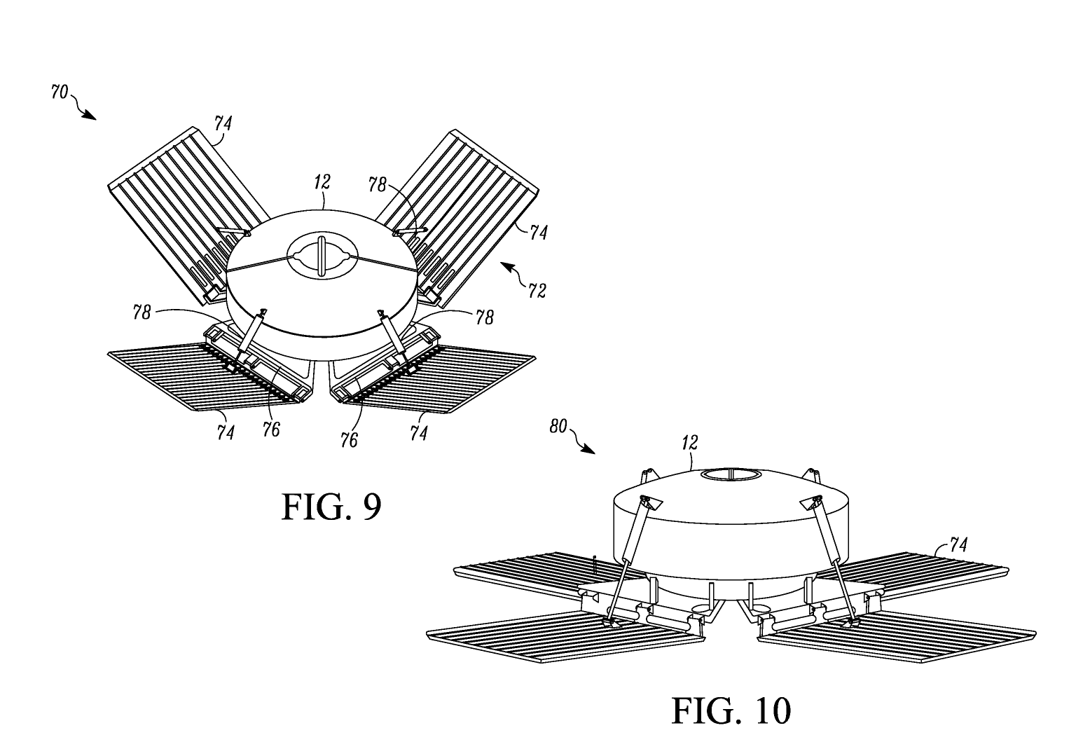

Many different constructions of shape change means can be utilized. For example, with reference to FIG. 9, a wave energy converter 70 is illustrated that includes a float that is identical to the float 12 in FIGS. 1-5. The converter 70 includes a shape change means 72 that is connected to the float 12 so that the shape change means 72 is disposed under the water surface with the bottom half of the float 12. In this example, the shape change means 72 comprises a plurality, for example four, generally radially extending, generally flat or planar panels 74. Each panel 74 is pivotally mounted at a radially inner end thereof to a support mechanism 76, for example a fixed bar, that is fixed to the lower half of the float 12. An actuator 78 is connected to each panel 74 with one end of each actuator 78 fixed to the top half of the float 12 and the opposite end of each actuator fixed to the panel. Actuation of the actuators 78 changes the orientation of the panels 74 from a generally vertical or retracted/fully open orientation (not shown) providing little virtual added mass, to generally radial or extended/fully closed position providing maximum virtual added mass. FIG. 9 shows the panels 74 approximately midway between the fully open and fully closed positions, and the panels can be positioned anywhere between the fully open and fully closed positions.

FIG. 10 illustrates another embodiment of a wave energy converter 80 that is similar in construction to the wave energy converter 70, except that the support mechanism to which the inner ends of the panels 74 are connected to comprises a plate that is fixed to the lower half of the float 12. This embodiment also illustrates the panels 74 in the radial or extended/fully closed position to provide maximum virtual added mass.

The virtual mass that is added is determined by the increased top plan view area of the converter that is added by the shape change means, which changes the amount of water that the converter pushes up and down. In one embodiment, when the shape change means is in the fully deployed or fully closed orientation, the shape change means adds an area approximately 2 to 4 times the area of the float. In another embodiment, the shape change means adds an area approximately 2.5 times the area of the float.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A wave energy converter, comprising:
a float having a float area; and
a shape change means attached to the float that is selectively and controllably actuatable to increase the float area that is acted on by the water.

2. The wave energy converter of claim 1, wherein the shape change means is actuatable between a fully open position and a fully closed position.

3. The wave energy converter of claim 1, wherein the shape change means is disposed to the side of the float such that in a top plan view, the area of the float that is acted on by the water can be selectively and controllably increased.

4. The wave energy converter of claim 2, wherein the shape change means comprises a plurality of pivoted flaps.

5. The wave energy converter of claim 1, wherein the converter is a point absorber wave energy converter.

6. A wave energy converter, comprising:
a float having a float area; and
a shape change mechanism attached to the float, the shape change mechanism includes a plurality of flaps that are selectively and controllably actuatable between a fully open position and a fully closed position to increase the float area that is acted on by the water.

7. The wave energy converter of claim 6, wherein the flaps are disposed to the side of the float such that in a top plan view, the area of the float that is acted on by the water can be selectively and controllably increased.

8. The wave energy converter of claim 7, wherein the flaps are pivotally mounted to pivot between the fully open position and the fully closed position.

9. The wave energy converter of claim 6, wherein the converter is a point absorber wave energy converter.

10. A method of mechanically tuning a wave energy converter, comprising:
selectively and controllably changing the shape of a float using a shape change mechanism connected to the float to change the amount of water that the converter pushes up and down.

11. The method of claim 10, wherein selectively and controllably changing the shape of the float comprises increasing the float area that is acted on by the water.

12. The method of claim 11, wherein the shape change mechanism comprises plurality of pivotable flaps that are actuatable between a fully open position and a fully closed position, and increasing the float area comprises actuating at least one of the flaps from the fully open position to the fully closed position.
